(19) United States
(12) Patent Application Publication
(10) Pub. No.: US 2022/0039213 A1
(43) Pub. Date: Feb. 3, 2022

(54) FLEXIBLE AND STRETCHABLE HEATER BASED ON CONDUCTIVE TEXTILE OR CONDUCTIVE POLYMERIC FOAM

(71) Applicant: IEE INTERNATIONAL ELECTRONICS & ENGINEERING S.A., ECHTERNACH (LU)

(72) Inventors: Driss CHABACH, Noertrange (LU); Matthias MASSING, Konz (DE)

(21) Appl. No.: 17/276,261

(22) PCT Filed: Sep. 13, 2019
(86) PCT No.: PCT/EP2019/074528

§ 371 Date: Mar. 15, 2021

(30) Foreign Application Priority Data
Sep. 14, 2018 (LU) LU100928

(51) Int. Cl. H05B 3/36; B62D 1/06; H05B 3/12; H05B 3/06

(52) U.S. Cl. CPC H05B 3/36; B62D 1/06; H05B 3/12; H05B 1/0236; H05B 2203/016; H05B 2203/007; H05B 3/06

(57) ABSTRACT

An electric heating device, in particular for automotive application, includes at least one heating member and electric terminals that are provided as electric connections connectable to an electric power supply. The heating member includes at least one dielectric, planar, flexible carrier formed as a textile carrier or as a polymeric foam carrier and having an upper surface and an opposite lower surface arranged in parallel to the upper surface, wherein at least one out of the upper surface and the lower surface is equipped with an attached continuous layer of electrically conductive material, which extends over a major part of an area of the respective surface of the at least one flexible carrier. At least one electric terminal is arranged at and electrically connected to each end of the electrically conductive material layer of each heating member.

### TECHNICAL FIELD

The invention relates to the technical field of electric heating, in particular for automotive applications. More specifically, the invention relates to electrical heating of vehicle interior parts such as steering wheels, arm rests, door panels, and so forth.

### BACKGROUND

Electric heating devices are widely used in the automotive industry for providing passenger comfort, for instance by heating a vehicle compartment in general, and/or passenger seats, and/or arm rests, and/or panels. Electric heating devices are also employed in vehicle steering wheels for heating right after start-up of a vehicle engine at cold ambient conditions.

It is considered as one requirement for such electric heating devices that they should be unnoticeable to the vehicle user if not put into operation. Other requirements may be an as even as possible heat density during operation in order to avoid hot spots that may become noticeable to the vehicle user, and also to avoid material fatigue by the occurrence of thermal stress.

These requirements generally rules out the use of conventional heating wires such as wires made from copper or from copper-nickel(-manganese) alloys, whose resistivity temperature dependence is very low.

Solutions have been proposed in the prior art that employ foil heater members, i.e. heater members having the appearance of a thin flexible foil or film.

For instance, international application WO 2015/024909 A1 describes a foil heater for a heating panel. The foil heater comprises a first and a second spiral resistive heating trace formed in a first and a second layer, respectively, that conforms to a flat or curved surface. Each of the first and second resistive heating traces has a center and at least one outer extremity. An electrically insulating layer is arranged between the first and second layer. The electrically insulating layer comprises an opening that accommodates an electrical via, through which the first and second resistive heating traces are electrically contacted with each other. The foil heater is compatible with operation at lower temperature. Due to their spiral shape, the heating traces can be routed densely over the entire heating surface substantially without crossings. A significantly more uniform temperature distribution can thus be achieved.

From WO 2018/098005 A2 a heater is known comprising a film, one or more coverings that extends along one or more sides the film, and one or more power application portions that apply power to the film so that the film heats up. The film is a graphite film. The heater may include a heating layer that is a film. The heater may be a heater film that is covered by one or more covering layers (e.g., an upper covering, a lower covering, or both). The film of the heater may be the layer that produces heat. The film may be formed as a sheet. Preferably, the film is a nonwoven sheet. The film may be made of any nonwoven material that conducts electricity and produces heat. The film may be made of any nonwoven material that may be cut, bent, folded, pierced, or a combination thereof and produce heat when power is applied. The one or more covering layers may function to support the film. The covering may function as a reinforcement for the film, a protectant, or both. The one or more covering layers may function to prevent the film from stretching, tearing, breaking, folding, wrinkling, or a combination thereof. The one or more covering layers may not be a substrate and may be added after the heater layer is formed. The one or more covering layers may function to keep film planar. The one or more covering layers may be adhered to the film. The terminal may directly and/or indirectly attach to the heating layer using any device so that electricity enters the heating layer through the terminals and the heating layer produces heat.

The geometry of a conventional vehicle steering wheel places higher demands on an “unnoticeable” installation at the steering wheel than an even or a slightly curved surface, as wrinkles must not be present despite the curved surface. Another requirement is that a heater member should cover an as large as possible surface of the steering wheel.

A solution particularly for steering wheel heating is described by international application WO 2016/096815 A1, in which a planar flexible carrier is proposed for use in steering wheel heating and/or sensing. The planar carrier, which can be employed for mounting on a rim of a steering wheel without wrinkles, comprises a portion of planar flexible foil of roughly rectangular shape having two longitudinal sides and two lateral sides. A length B of the lateral sides is 0.96 to 1.00 times the perimeter of the rim. A number of N cut-outs per unit length are provided on each of the longitudinal sides, wherein the cut-outs of one side are located in a staggered fashion relative to opposing cut-out portions on the opposite side.

In one embodiment proposed in WO 2016/096815 A1, a planar, flexible carrier which covers a maximum of the rim surface area supports a parallel electrical heating circuit and so constitutes a heating member. Two of these heating members are attached on the steering wheel rim so that their contacted sides abut to each other and contacts of the same electrical potential are also abutting. The planar, flexible carrier consists of thermo-stabilized, 75 μm polyester foil. The foil serves as a substrate for the polymer thick film (PTF) electrical heating circuit which is applied in three printing passes by flat bed or rotary screen printing. The parallel electrical circuit is applied using a highly conductive PTF silver for the feedlines and for heating, and a low conductive PTF carbon black exhibiting positive temperature coefficient of resistivity (PTCR) characteristics for heating. A print thickness is typically between 5 and 15 μm. The document also describes the use of a stretchable planar flexible foil as a planar carrier for further shaping enhancement.

Another approach has been taken by international application WO 2013/050621 A2, which describes electrically conductive textiles for occupant sensing and/or heating applications, wherein the sensor and/or heater can be attached from the backside to a surface such as a driver seat, a passenger seat, a backseat, a steering wheel, a door side of compartment, a gear shift lever, etc.

A flexible heater and/or electrode comprises a woven textile material having a warp direction and a weft direction. The textile material comprises at least one region having a low electrical conductance and at least two regions having a high electrical conductance. The at least two regions of high electrical conductance are adjacent to the at least one region of low electrical conductance. At least one of the at least two regions of high electrical conductance is operatively connected to a connection terminal of the heater and/or electrode, wherein the connection terminal serves for connecting the heater and/or electrode to an electronic control circuit.

Furthermore, EP 2 572 942 A1 describes a capacitive sensing system for being connected to a heating element. The capacitive sensing system comprises a capacitive detector connectable to the heating element and a common mode choke for essentially preventing alternating current from flowing from the heating element to the heating current supply. The capacitive detector is configured for driving an alternating current into the heating element and for producing an output indicative of capacitance based upon the alternating current. The choke has a first and a second winding for connecting the heating element with the heating current supply. The choke comprises a third winding connected in parallel of the first and/or second winding. The capacitive detector is configured for measuring a portion of the alternating current flowing across the third winding and for taking into account the measured portion of alternating current when producing the output. The heating element may comprise a conductive wire, cable, fibre, bundle of fibres or a conductive track (e.g. made of a PTC material) printed on a flexible support. The heating element has a first and a second terminal connected to a first and a second terminal of a heating current supply respectively.

### SUMMARY

It is therefore an object of the invention to provide an electric heating device, in particular for automotive applications, which is as unnoticeable to a user as possible if not put into operation, and by which an occurrence of hot spots during operation can be avoided.

In one aspect of the present invention, the object may be achieved by an electric heating device, which comprises at least one heating member that in turn includes at least one dielectric, planar, flexible carrier formed as a textile carrier or as a polymeric foam carrier and having an upper surface and an opposite lower surface arranged in parallel to the upper surface. At least one out of the upper surface and the lower surface is equipped with an attached continuous layer of electrically conductive material, which extends over a major part of an area of the respective surface of the at least one flexible carrier. At least one electric terminal is arranged at and is electrically connected to each end of the electrically conductive material layer of each heating member, wherein the electric terminals are provided as electric connections that are connectable to an electric power supply.

The present invention is beneficially employable in particular in the field of automotive applications, but could also be used with advantage in building construction or in medical applications.

The term “automotive”, as used in this patent application, shall particularly be understood as being suitable for use in vehicles including passenger cars, trucks, semi-trailer trucks and buses.

For the purposes of the present invention, the term “flexible carrier” shall particularly be understood to encompass carriers, which in a free-standing manner are unable to withstand any external force acting in a direction transverse to a direction of their extension and thus show virtually zero resilience, and also to encompass carriers that show very little resilience and that can easily be distorted by hand and without any use of a tool by an operator, for instance during installation. Textiles or polymeric foam materials as carrier are available in a large variability, and vast experience exists regarding mechanical properties and production methods. Thus, appropriate materials can be selected from a large pool in order to meet existing application requirements.

The term “major part”, as used in this application, shall be understood as a portion of more than 60%, more preferable of more than 70%, and, most preferable, of more than 80%.

Due to the planar surfaces and the flexibility of the employed carrier, the proposed electrical heating device can be installed almost unnoticeable to a user. When the electric terminals are connected to an electric power supply, heat is being generated in an area portion which is a major part of the area of the flexible carrier, and thus a local heat density can be kept low and the occurrence of hot spots generated by a large local heat density can virtually be avoided.

The continuous layer of electrically conductive material can be attached to at least one out of the upper surface and the lower surface by applying a physical vapor deposition (PVD) method such as evaporation or sputtering, or can be attached galvanically by electroplating.

For the purposes of the present invention, the term “textile” shall particularly be understood to encompass any flexible material consisting of a network of natural or synthetic fibers, e.g. yarns or threads. Yarn may be produced by spinning raw natural fibers such as wool, flax, cotton, hemp, or other materials such as synthetic fibers, to produce long strands. Textiles may be produced by weaving, knitting, crocheting, knotting, felting, or braiding. Woven textiles are to be understood in particular as a surface fabric comprising at least two interlaced thread systems arranged essentially perpendicular to one another (for instance warp and weft). In this context, a knitted textile or knitted fabric is to be understood in particular to mean a textile produced by interlooping of yarns. The term “textile” shall also include non-woven fabrics made from intermingled or bonded-together fibers and shall encompass felt, which is neither woven nor knitted.

The polymeric foam carrier may be made from, without being limited to, expanded polyolefin foams such as expanded polyethylene foam (EPE foam), flexible polyurethane (PUR) foams, or a combination of at least two of these foams.

An electric resistance of the continuous layer of electrically conductive material attached to, for instance, a surface of a textile can be adjusted by selecting a type of textile, a material for the electrically conductive material, and an applied conductive material area weight. This design freedom can allow to cover any heating power requirements of, for instance, a steering wheel heater device and a large range of other heater applications, such as a vehicle arm rest, vehicle door or dashboard panel heaters, and so forth.

In preferred embodiments of the electric heating device, in an operable state, the at least one heating member comprises a double bend in opposite directions and perpendicular to a direction of the largest extension such that in a direction perpendicular to the upper and the lower surface, at least one overlap region is formed comprising at least three regions of the continuous electrically conductive material layer of the at least one heating member. The phrase “direction of the largest extension”, as used in this application, shall be understood as a path connecting the ends of the at least one flexible carrier, wherein the path runs parallel to an edge of the at least one flexible carrier.

By that, at least two regions of the at least three regions of the continuous electrically conductive material layer are electrically connected in parallel, which results in a lower electric resistance per unit length of the overlap region compared to the balance of the electrically conductive layer. With the same electric current flowing through the overlap region as through the balance of the electric conductive layer, less electric power is dissipated in the overlap region and the heat flux density, i.e. heat energy per unit area per time, is locally reduced there. This can beneficially be used as a design tool for specifically lowering the local heat flux density in a desired region.

Preferably, the electric heating device comprises a plurality of heating members that are arranged such that portions of their respective continuous electrically conductive layers are electrically connected in parallel. By that, an electric resistance can be reduced in these portions, which results, compared to a balance of each of the heating members, in a reduced heat flux density in these portions during operation of the electric heating device. In this way, a design tool can be provided for beneficially lowering a local heat flux density in desired regions.

The term “plurality”, as used in this patent application, shall particularly be understood to express a quantity of at least two.

In preferred embodiments of the electric heating device, the continuous electrically conductive material layer comprises at least one continuous region that is split up in a plurality of strips running in parallel to the direction of the largest extension and being electrically connected in parallel. A total sum of widths of the strips is smaller than a width of the continuous electrically conductive material layer adjacent to ends of the strips. By selecting suitable width dimensions for each strip of the plurality of strips, a local heat flux density can beneficially be adjusted in a direction perpendicular to the direction of the largest extension.

Preferably, the at least one heating member comprises at least one region of a 180° direction change in a plane. By that, the electric terminals that are electrically connected to the ends of the electrically conductive material layer can be arranged adjacent to each other, so that a return line to the electric power supply that would have to run all along the extension of the heating member and that would require extra measures to keep the heating member unnoticeable can be omitted.

In preferred embodiments of the electric heating device, the electrically conductive layer includes at least one region of a 180° direction change in a plane, which in turn comprises a plurality of meander-shaped strips whose ends are electrically connected. A ratio of a length and a width of each of the meander-shaped strips is essentially equal.

The term “essentially equal”, as used in this application, shall particularly be understood as being equal within a margin of ±30%, preferably within a margin of ±20%, and, most preferably, within a margin of ±15%. In this way, an even heat flux density distribution can be accomplished in the region of the 180° change in direction despite the naturally existing different path lengths between an inner path and an outer path.

In preferred embodiments of the electric heating device, at least one electrically conductive layer of the at least one heating member comprises at least one material out of a group formed by copper, nickel, silver, manganese and a combination of at least two of these. By that, a wide range of electric sheet resistances can readily be provided. In suitable embodiments, a high degree of corrosion resistance in the presence of high humidity and a large stretching ability without breakage can be achieved.

A desired level of heat flux density can be achieved if the electric heating device comprises a plurality of heating members, which are attached one on the other at the same location in a mutually insulated way, and that are electrically connectable in parallel to the electric power supply.

Preferably, the heating members of the plurality of heating members are mechanically connected by adhesive bonds for easy installation.

It is further proposed to use at least one electric heating device disclosed herein for heating a vehicle steering wheel.

Moreover, it is proposed to use at least one heating member of the electric heating device disclosed herein as an antenna of a capacitive sensing device for automotive application. Capacitive sensing devices for automotive applications that employ a heating member are known in the art, for instance from US 2011/0148648 A1. This document shall hereby be incorporated by reference in its entirety with effect for those jurisdictions permitting incorporation by reference.

These and other aspects of the invention will be apparent from and elucidated with reference to the embodiments described hereinafter.

It shall be pointed out that the features and measures detailed individually in the preceding description can be combined with one another in any technically meaningful manner and show further embodiments of the invention. The description characterizes and specifies some embodiments of the invention in particular in connection with the figures.

### BRIEF DESCRIPTION OF THE DRAWINGS

Further details and advantages of the present invention will be apparent from the following detailed description of not limiting embodiments with reference to the attached drawing, wherein:

FIG. 1 schematically illustrates a possible embodiment of an electric heating device in accordance with the invention in a plan view,

FIG. 2 schematically illustrates a detail of an alternative embodiment of an electric heating device in accordance with the invention in a perspective view,

FIG. 3 schematically illustrates another alternative embodiment of an electric heating device in accordance with the invention in a perspective view, and

FIG. 4 schematically illustrates another alternative embodiment of an electric heating device in accordance with the invention in a plan view.

In the various figures, same parts are always provided with the same reference numerals. Thus, they are usually described only once.

### DESCRIPTION OF PREFERRED EMBODIMENTS

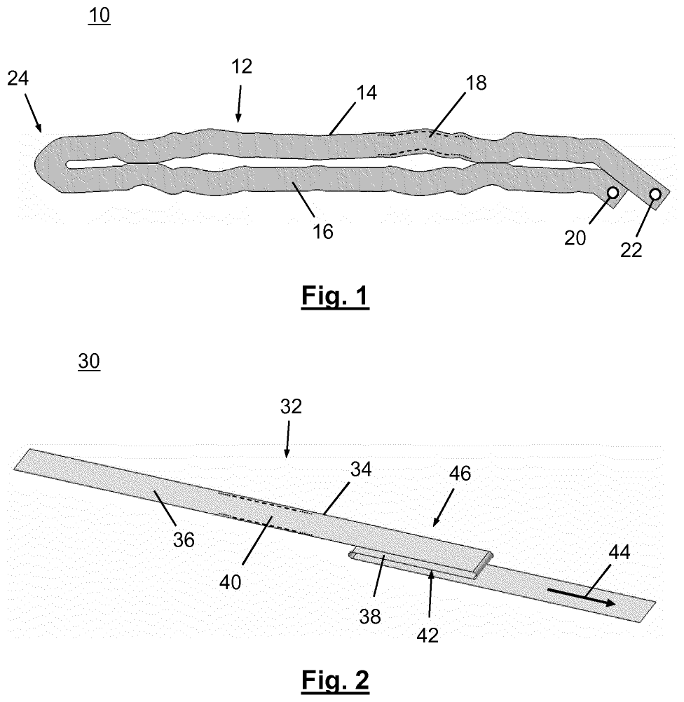

FIG. 1 schematically illustrates a possible embodiment of an electric heating device 10 in accordance with the invention. The electric heating device 10 is intended and configured to be used for heating a vehicle steering wheel (not shown).

The electric heating device 10 comprises one heating member 12. The heating member 12 includes a dielectric, planar, flexible carrier 14 that is formed as a textile carrier completely made from polyester. The textile carrier has a longish belt-like shape with two portions having essentially straight largest extensions and a plurality of small transverse deviations, and a low cross-section with an upper surface 16 and an opposite lower surface (not shown), which is arranged in parallel to the upper surface 16. The upper surface 16, which in FIG. 1 coincides with the drawing plane, is equipped with an attached continuous layer of electrically conductive material 18 consisting of nickel. In this specific embodiment, the nickel layer 18 has been applied to the upper surface 16 by using a physical vapor deposition (PVD) process, namely by vacuum evaporation deposition. Alternatively, it may have been attached by another PVD process or galvanically by employing an electroplating process. The nickel layer 18 extends over a major part of more than 90% of the area of the upper surface 16.

In alternative embodiments of the heating member, the textile carrier may be replaced by a polymeric foam carrier.

Further, the electric heating device 10 includes two electric terminals 20, 22. One electric terminal 20, 22 each is arranged at and electrically connected to ends of the electrically conductive material layer 18 of the heating member 12. The electric terminals 20, 22 serve as electric connections to an electric power supply that may be positioned remote from the steering wheel within the vehicle.

In a middle region of its longish extension, the heating member 10 comprises a region of a 180° direction change 24 in a plane, by which a potentially disturbing return line for an electric current flowing through the electrically conductive material layer 18 can be avoided.

The nickel layer 18 has a uniform thickness t and width w along a length of extension l. Its electric resistance R can be obtained from a sheet resistance R_{S} and its geometric dimensions by

$$R = {R}_{S} \cdot \frac{l}{w} , {R}_{S} := \frac{ρ}{t} \qquad ( 1 )$$

wherein ρ denotes the specific electric resistivity of the electrically conductive material layer 18.

For the following parameters
t=5·10⁻⁶ m
w=10⁻² m
l=1 m, and
ρ=7.2·10⁻⁸ Ω·m (for nickel)
   a heating power of about 100 W can be achieved by providing a power supply voltage of 12 V. Of course, lower average heating power levels can be achieved for instance by applying a reduced operating voltage or by pulse-width modulation techniques, as is well known in the art.

The heating member 12 pursuant to FIG. 1 shows a total electric resistance of about 1.4Ω and is further intended to be used as an antenna of the capacitive sensing device for automotive sensing applications, in particular for use in a hands-on detection capacitive sensing device, as is known in the art for instance from WO 2016/096815 A1, which document shall hereby be incorporated by reference in its entirety with effect for those jurisdictions permitting incorporation by reference.

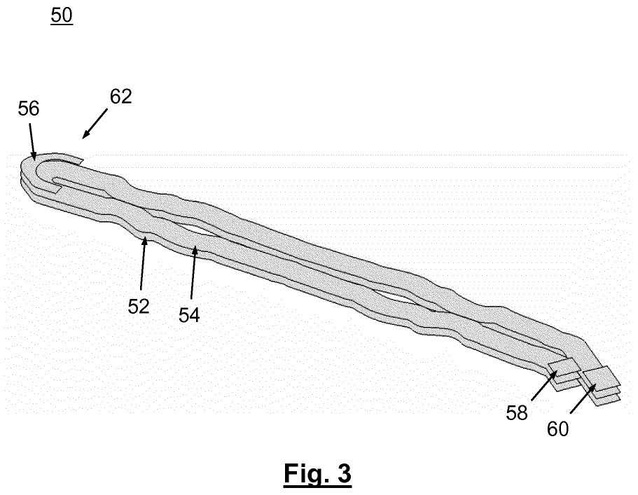

FIG. 2 schematically illustrates a heating member 32 of an alternative embodiment of an electric heating device 30 in accordance with the invention.

The heating member 32 includes a dielectric, planar, flexible carrier 34 that is formed as a textile carrier that is completely made from polyamide. The textile carrier has a longish, straight belt-like shape and a low cross-section with an upper surface 36 and an opposite lower surface 38, which is arranged in parallel to the upper surface 36. The upper surface 36 is equipped with an attached continuous layer of electrically conductive material 40 comprising a mixture of nickel and copper. The electrically conductive material layer 40 has a uniform thickness t and width w along a length of extension. The electrically conductive material layer 40 may have been applied to the upper surface 36 by using a PVD process, namely by a sputtering process, in which nickel and copper are simultaneously deposited on the flexible carrier 34. The use of another PVD process that appears suitable to those skilled in the art is also contemplated.

For illustration purposes, FIG. 2 shows the heating member 32 in a somewhat expanded view. In an operable state, the heating member 32 comprises a double bend 42 in opposite directions and perpendicular to a direction of the largest extension 44 of the flexible carrier 34. By the double bend 42, an overlap region 46 is formed in a direction perpendicular to the upper surface 36 and the lower surface 38. The overlap region 46 comprises three regions of the continuous electrically conductive layer 40 of the heating member 32. In the operable state, the three regions are in tight contact and two of them are electrically connected in parallel. The electric resistance per unit length is reduced in the overlap region 46 compared to a balance of the heating member 32, and thus, a heat flux density is also reduced when the heating member 32 is put into operation.

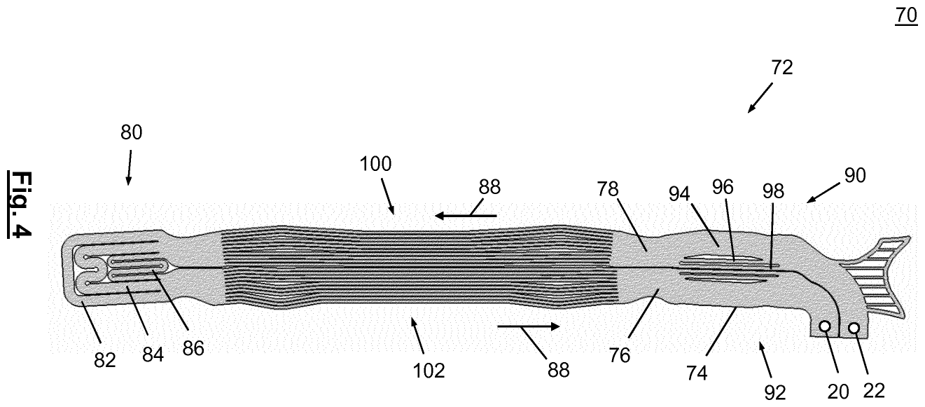

FIG. 3 schematically illustrates another alternative embodiment of an electric heating device 50 in accordance with the invention in a perspective view. The electric heating device 50 comprises a plurality of five heating members 52-60, a first 52 and a second 54 of which are identically designed to the heating member 12 of the electric heating device 10 pursuant to FIG. 1. In contrast to these two heating members 52, 54, a lower surface of the third 56, fourth 58 and fifth heating member 60, respectively, is equipped with an attached continuous layer of electrically conductive material, namely nickel. The third heating member 56 is arranged in a region of a 180° direction change 62. The fourth 58 and the fifth heating member 60 are arranged to cover ends of the two identical heating members 52, 54. It is noted herewith that the terms “first”, “second”, etc. are used in this application for distinction purposes only, and are not meant to indicate or anticipate a sequence or a priority in any way.

The two identical heating members 52, 54 are attached one on the other at the same location in a mutually electrical insulated way connected by adhesive bonds, and are connectable in parallel to an electric power supply by electric terminals located at their ends (not shown), similar as in the embodiment pursuant to FIG. 1. By that, a heating power level of the electric heating device 50 can be doubled compared to the embodiment pursuant to FIG. 1 when put into operation. As the third heating member 56 is equipped with the electrically conductive material layer on the lower surface, in an operational state portions of the electrically conductive material layer of the second heating member 54 and the third heating member 56, respectively, are electrically connected in parallel. Thus, the electric resistance per unit length is reduced by the third heating member 56 compared to the balance of the electric heating device 50, and thus, a heat flux density is reduced in the region of a 180° direction change 62 when the electrical heating device 50 is put into operation. By the same principle, a heat flux density is reduced in a region comprising the ends of the two identical heating members 52, 54 for avoiding an occurrence of hot spots during operation.

FIG. 4 schematically illustrates another alternative embodiment of an electric heating device 70 in accordance with the invention in a plan view. The electric heating device 70 has a heating member 72 whose outward shape resembles that of the heating member 12 of the electric heating device 10 pursuant to FIG. 1.

The heating member 72 includes a dielectric, planar, flexible carrier 74, which is formed as a textile carrier that is completely made from polyester. The textile carrier has a longish belt-like shape with two portions having an essentially straight largest extension and a plurality of small transverse deviations, and a low cross-section with an upper surface 76 and an opposite lower surface (not shown), which is arranged in parallel to the upper surface 76. The upper surface 76, which in FIG. 4 coincides with the drawing plane, is equipped with an attached continuous layer of electrically conductive material 78 consisting of nickel. The electrically conductive material layer 78 has a uniform thickness along a length of extension. The nickel layer 78 may have been applied to the upper surface 76 by using a PVD process, namely by vacuum evaporation deposition, or by any other PVD process that appears suitable to those skilled in the art. The nickel layer 78 extends over a major part of more than 95% of the area of the upper surface 76.

The electrically conductive layer 78 includes a region of a 180° direction change 80 in a plane, which comprises a plurality of three meander-shaped strips 82, 84, 86. Ends of the three meander-shaped strips 82, 84, 86 are electrically connected, so that the three strips 82, 84, 86 are electrically connected in parallel. A width of the meander-shaped strip 82 arranged at the outside of the region of the 180° direction change 80 is larger than a width of the meander-shaped strip 84 arranged at the middle part of the region of the 180° direction change 80, which in turn is larger than a width of the meander-shaped strip 86 arranged at the inside of the region of the 180° direction change 80. A length of the meander-shaped strip 82 arranged at the outside of the region of the 180° direction change 80 is larger than a length of the meander-shaped strip 84 arranged at the middle part of the region of the 180° direction change 80, which in turn is larger than a length of the meander-shaped strip 86 arranged at the inside of the region of the 180° direction change 80.

A ratio

$$\frac{l}{w}$$

of the respective length and the respective width of each of the meander-shaped strips 82, 84, 86 is essentially equal within the margin of ±10%. Thus, according to formula (1), an electric resistance of the meander-shaped strip 82 arranged at the outside, an electric resistance of the meander-shaped strip 84 arranged at the middle part and an electric resistance of the meander-shaped strip 86 arranged at the inside of the region of the 180° direction change 80 are equal within the given margin. As the three meander-shaped strips 82, 84, 86 are electrically connected in parallel, electric currents flowing through each of the three strips 82, 84, 86 are equal within the margin of ±10%, and a heat flux density is also equal to the same extent, avoiding an occurrence of any hot spots in this region.

Moreover, the continuous electrically conductive material layer 78 includes two continuous regions 90, 92 that are each split up in a plurality of three strips 94, 96, 98 running in parallel to a direction of the largest extension 88.

The working principle is the same for the two continuous regions 90, 92 split-up in a plurality of three strips 94, 96, 98. It will therefore be sufficient to exemplarily describe the working principle for one 90 of these continuous regions 90, 92.

The strips of the plurality of three strips 94, 96, 98 are electrically connected in parallel. A total sum of widths of the three strips 94, 96, 98 is smaller than a width of the continuous electrically conductive material layer 78 adjacent to ends of the three strips 94, 96, 98.

A ratio

$$\frac{l}{w}$$

of a respective length and a respective width of each of the three strips 94, 96, 98 is different. The ratio

$$\frac{l}{w}$$

for the strip 94 arranged at an outside of the region 90 of the heating member 72 is smaller than the ratio

$$\frac{l}{w}$$

for the strip 96 arranged in a middle region of the region 90 of the heating member 72, which in turn is smaller than the ratio

$$\frac{l}{w}$$

for the strip 98 arranged at an inside region of the region 90 of the heating member 72.

Therefore, a heat flux density per unit length for the strip 94 arranged at the outside of the heating member 72 is larger than a heat flux density per unit length for the strip 96 arranged in a middle region of the heating member 72, which in turn is larger than a heat flux density per unit length for the strip 98 arranged at an inside region of the heating member 72.

Furthermore, the continuous electrically conductive material layer includes two continuous regions 100, 102 that are split up in a plurality of ten strips running in parallel to the direction of the largest extension 88.

The working principle is the same for the two continuous regions 100, 102 split-up in a plurality of ten strips. It will therefore be sufficient to exemplarily describe the working principle for one 100 of these continuous regions 100, 102.

A total sum of widths of the ten strips is smaller than a width of the continuous electrically conductive material layer 78 adjacent to ends of the ten strips. Therefore, for a given length, a ratio

$$\frac{l}{w}$$

of the length and a width of the continuous electrically conductive material layer 78 adjacent to ends of the ten strips is smaller than a ratio of the length and the total sum of widths of the ten strips. As the same total electric current is flowing through the plurality of ten strips and the continuous electrically conductive material layer 78 adjacent to ends of the ten strips when the electrical heating device 70 is put into operation, a heat flux density per unit length is larger in the region 100, 102 split up in a plurality of ten strips than in the continuous electrically conductive material layer 78 adjacent to ends of the ten strips.

While embodiments of the invention have been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, which is meant to express a quantity of at least two. The mere fact that certain measures are recited in mutually different dependent claims does not indicate that a combination of these measures cannot be used to advantage. Any reference signs in the claims should not be construed as limiting scope.

1. An electric heating device, in particular for automotive application, comprising:
at least one heating member including at least one dielectric, planar, flexible carrier being formed as a textile carrier or as a polymeric foam carrier and having an upper surface and an opposite lower surface arranged in parallel to the upper surface, wherein at least one out of the upper surface and the lower surface is equipped with an attached continuous layer of electrically conductive material, which extends over a major part of an area of the respective surface of the at least one flexible carrier, and
at least one electric terminal arranged at and electrically connected to each end of the electrically conductive material layer of each heating member, wherein the electric terminals are provided as electric connections that are connectable to an electric power supply.

2. The electric heating device as claimed in claim 1, wherein, in an operable state, the at least one heating member comprises a double bend in opposite directions and perpendicular to a direction of the largest extension such that in a direction perpendicular to the upper and the lower surface, at least one overlap region is formed comprising at least three regions of the continuous electrically conductive layer of the at least one heating member.

3. The electric heating device as claimed in claim 1, comprising a plurality of heating members that are arranged such that portions of their respective continuous electrically conductive layers are electrically connected in parallel.

4. The electric heating device as claimed in claim 1, wherein the continuous electrically conductive material layer comprises at least one continuous region that is split up in a plurality of strips running in parallel to the direction of the largest extension, and being electrically connected in parallel, wherein a total sum of widths of the strips is smaller than a width of the continuous electrically conductive material layer adjacent to ends of the strips.

5. The electric heating device as claimed in claim 1, wherein the at least one heating member comprises at least one region of a 180° direction change in a plane.

6. The electric heating device as claimed in claim 1, wherein the electrically conductive layer includes at least one region of a 180° direction change in a plane, which comprises a plurality of meander-shaped strips whose ends are electrically connected, and wherein a ratio of a length and a width of each of the meander-shaped strips is essentially equal.

7. The electric heating device as claimed in claim 1, wherein at least one electrically conductive layer of the at least one heating member comprises at least one material out of a group formed by copper, nickel, silver, manganese and a combination of at least two of these.

8. The electric heating device as claimed in claim 1, comprising a plurality of heating members, which are attached one on the other at the same location in a mutually insulated way, and that are electrically connectable in parallel to the electric power supply.

9. The electric heating device as claimed in claim 1, wherein the electric heating device comprises a vehicle steering wheel heater.

10. The electric heating device as claimed in claim 1, wherein the at least one heating member of the electric heating device comprises an antenna of a capacitive sensing device for automotive application.
